(19) United States
(12) Patent Application Publication
(10) Pub. No.: US 2010/0073192 A1
(43) Pub. Date: Mar. 25, 2010

(54) SYSTEM AND METHOD FOR PROVIDING AUTOMATED METER MANAGEMENT LAYER INTELLIGENCE TO A POWER LINE COMMUNICATIONS SYSTEM

(75) Inventors: Shmuel Goldfisher, Petach-Tikva (IL); Rami Refaeli, Kfar-Saba (IL)

Correspondence Address: MARTIN D. MOYNIHAN d/b/a PRTSI, INC., P.O. BOX 16446, ARLINGTON, VA, 22215, US

(73) Assignee: Main.Net Communications Ltd., RaAnana (IL)

(21) Appl. No.: 12/519,827

(22) PCT Filed: Dec. 19, 2007
(86) PCT No.: PCT/IL07/01574

§ 371 Date: Jun. 18, 2009

Related U.S. Application Data
(60) Provisional application No. 60/870,616, filed on Dec. 19, 2006.

(51) Int. Cl. G08C 15/06

(52) U.S. Cl. 340/870.02

(57) ABSTRACT

A system and method are provided to enable automated broadband AMR, optionally in real time. The system may include an Automated Meter Management Server and an Automated Meter Reading Converter, wherein the Automated Meter Management Server utilizes data generated by a Poller Converter and a Name Server, to enable automated data collaboration between Automated Meter Reading meters and a Power Line Communications System.

### CROSS REFERENCE TO RELATED APPLICATIONS

This application claims priority from U.S. Provisional Patent Application No. 60/870,616, filed Dec. 19, 2006, entitled “System and method for providing automatic meter reading layer intelligence to a power line communications network”, which is incorporated in its entirety herein by reference.

### FIELD OF THE INVENTION

The present invention relates to methods and devices useful in providing automatic meter management layer functionality in a power line communications system.

### BACKGROUND OF THE INVENTION

Automatic Meter Reading (AMR) generally refers to technologies for automatically collecting data from metering devices (e.g. water, gas, electric) and transferring that data to a central database for billing and/or analyzing. AMR aims to enable billing that can be based on actual consumption rather than on an estimate based on previous consumption, and giving customers better control of their consumption.

In general, AMR in power line communication (PLC) networks enables electronic data to be transmitted over power lines back to the substation, then relayed to a central computer in the utility's main office. This would be considered a type of fixed network system—the network being the distribution network which the utility has built and maintains to deliver electric power. However, in most cases the native PLC system does not typically handle application layer implementations, and the PLC system devices may not be familiar with the different end devices and languages. For example, different meters may be connected to a PLC system, for example, via Ethernet ports using external serial-to-IP Converters, or via internal Converters. In many cases the correlation between the AMR world and the PLC and Internet Protocol (IP) world are very limited or non-existent.

It would be highly advantageous to have an electric meter reading system or advance metering infrastructure that may be automatically correlated with the PLC system, to enable, for example, automated updates following device setup, changes, and developments.

### SUMMARY OF THE INVENTION

There is provided, in accordance with an embodiment of the present invention, an apparatus, system, and method for providing Automated Broadband AMR management in real time. Embodiments of the present invention may form at least a part of an Automated Meter Management (AMM) or Advanced Metering Infrastructure (AMI) system, which may enable transforming automated meter reading (AMR) data collected from metering devices (e.g., electric, gas, and water meters) in a Power Line Communications (PLC) system into an intelligent manageable system.

According to some embodiments, a PLC system management system may be able to automatically detect, validate and collaborate with AMR devices that are added to a Power line network. A variety of client meter devices and types may be used. According to some embodiments broadband meters or clients may be used to create a real time broadband AMR implementation in a PLC system. In some embodiments real time information from multiple AMR's may be supplied to a PLC system. According to some embodiments an intelligent and scalable AMR functionality may be provided to a PLC system, as new units may be automatically integrated into the network.

According to some embodiments a method for automatically registering a new AMR meter or client may include getting, by a Converter, an IP Configuration and a Name Server (NSRV) address from DHCP; sending, by the Converter, a name registration message to the NSRV with a unique identifying Converter Name (CNAME); updating, by the NSRV, a Poller Converter (PoCo), either by notifying it, or by the PoCo initiating a continuous update check procedure; and starting, by the PoCo, a meter discovery process by accessing the Converter.

According to some embodiments a method for automatically accessing of the Converter, to implement real time collaboration with an AMR meter or client, may include sending, by an AMM Server, a query to the PoCo asking for the

CNAME correlated with the Identification Number, for example, the Serial ID (SID) of the AMR meter; with the resulting CNAME, accessing the Converter, by the AMM Server, using the NAME protocol, and optionally sending a query to the NSRV, by the Converter; connecting the CNAME to the IP, thereby enabling the AMM Server to connect to the relevant Converter. In some embodiments read actions invoked by the AMM Server may have authentication processes before the actions are implemented. In some embodiments, by using CNAME instead of IP, the system may not need to keep an updated IP map for each device in the network; rather updates may be made using a standard protocol to a centralized Server.

According to some embodiments a system for enabling automated correlating of AMR data in a broadband PLC system is provided, including: an Automated Meter Management (AMM) Server to serve Automated Meter Reading (AMR) data to the PLC system; a Converter, to convert data from a Meter to an IP protocol; a Name Server (NSRV), to correlate a Converter Name (CNAME) and Converter IP address; and a Poller Converter, to provide the

CNAME and Meter information data to the AMM Server. In some embodiments the name Server includes a service application and a Name Protocol Stack. In some embodiments the Poller Converter includes a Poller application associated with a NSRV Connection Stack and an AMR Connection Stack. In further embodiments the Poller Converter includes a Poller application associated with a logger unit and a Name database. In still further embodiments the automated correlation occurs substantially in real time. In additional embodiments the automated correlation is executed substantially simultaneously for multiple AMR clients.

According to some embodiments a method for enabling automated correlation of AMR data in a broadband PLC system is provided, including: implementing an automated registration process to associate a meter Converter with an AMR client; using a Name Server (NSRV) to keep an updated list of Converter Name-to-IP data; correlating the Converter Name and Serial ID (SID) for each client; and obtaining client AMR data to be provided to the PLC system. In some embodiments the step of authenticating a meter state may be executed before obtaining client AMR data. In further embodiments the registration process may include receiving IP Configuration data from a DHCP process, by a Converter; using a Name Server (NSRV) to get an NSRV address for an AMR client, by the Converter; sending a name registration message to the NSRV, with a unique identifying Converter Name (CNAME); updating a Poller Converter (PoCo) with the CNAME for each client; and starting a meter discovery process, by the PoCo, by accessing the Converter. In additional embodiments the obtaining client AMR data may include: sending a query to a PoCo asking for the CNAME correlated with the SID; using said CNAME, by the AMM Server, to access the Converter; and using the CNAME to IP process to connect between said AMM Server and the Converter. In a further embodiment an authentication process may precedes a read action invoked by the AMM Server.

According to some embodiments a Poller Converter process may be provided to enable automated AMR management in a broadband PLC system. The Poller Converter process may be include automatically registering an AMR client on the PLC system; such registering being handled by a Poller Converter (PoCo) unit coupled to a Name Server; and accessing the AMR client in real time, by an AMM Server, to provide broadband AMR management.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic diagram illustrating a Converter registration process, according to some embodiments;

FIG. 2 is a schematic diagram illustrating a process of an AMM Server accessing a Converter, according to some embodiments;

FIG. 3 is a schematic illustration of aspects of the PoCo and NSRV general architecture, according to some embodiments;

FIG. 4 is a flow chart illustrating an example of an Automatic Meter Rules Implementation, according to some embodiments; and

FIG. 5 is a flow chart illustrating an example of an automated meter detection Implementation, according to some embodiments.

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

In the following detailed description, numerous specific details are set forth in order to provide a thorough understanding of the present invention. However, it will be understood by those skilled in the art that the present invention may be practiced without these specific details.

The term “Automated Meter Reading” or the word “AMR” as used herein may encompass various automated meter reading applications, apparatus, devices and services, including meters for electricity, gas, water or other utilities. The term “Automated Meter Management” or the word “AMM” as used herein may encompass a variety of metering management systems, including Advanced Metering Infrastructure (AMI) applications, devices and services. The term “real time” as used herein may encompass data communications that occur substantially immediately, in general in an automated fashion and not requiring manual intervention.

Embodiments of the present invention enable provision of AMR layer intelligence to a power line communications (PLC) network, for example, to provide Broadband Automated Meter Management (AMM) Layer services in real time. According to some embodiments, an AMM system may be able to automatically detect and collaborate with AMR devices that are added to a Power line network. A variety of client meter devices and types may be used. According to some embodiments broadband meters or clients may be used to create a real time broadband AMM implementation in a PLC system. In some embodiments real time information from multiple AMR's may be supplied to a PLC system. According to some embodiments an intelligent and scalable AMR functionality may be provided to a PLC system, as new units may be automatically integrated into the system.

In particular, in some embodiments, a Poller Converter (PoCo) element may be used to handle the application layer of an AMM system. Since the native PLC system does not typically handle the application layer, the PLC system devices may not be familiar with the different end-devices and languages (which, in this case, may refer to the different meters which are connected to a PLC system, for example, via an Ethernet port using external serial-to-IP Converter, or via an internal Converter). Amongst the PoCo's main tasks is to correlate between the AMR world and Internet Protocol (IP) world, over the PLC system. For example, the PoCo may be used to add automation for the correlation between the Metering world and the IP Management world.

In the “AMR world”, a key element typically used for detecting a meter is the meter's serial ID (SID). The SID is generally used as the unique identifier of a client. In the “IP/PLC world”, each Converter that is connected to the AMM system may be marked with its Ethernet MAC address and IP address. In order to create an easy representation of these Converters, and in order to remove the need for IP addresses and MAC addresses, a naming method may be used. For this purpose, a Name Server (NSRV) may be in charge of keeping the name-to-IP entries updated using a registration process from modems or Converters associated with AMR units (i.e. AMRplus, from MainNet Communications of Ra'anana, Israel).

According to some embodiments, such a NSRV may correlate the Converter NAME to IP, and the PoCo may correlate between CNAME and SID. PoCo's other tasks may include, for example, Automatic discovery of meter type and protocol; Log activity in terms of meters' connections, replacing, lost, etc. In some embodiments, NSRV may be implemented as a service on the PoCo machine.

Since the connection between an Internal and External Converter to a meter generally uses a serial protocol, which does not implement connection state discovery, the Converter may not know anything regarding the state of the meter, for example, whether it is connected, disconnected, needing replacing, etc. Due to that, before performing each reading from a meter an authentication process may be included before obtaining the client data.

NSRV is an entity that may be dedicated to the AMM system. Even though it may use standard protocols for this purpose, the NSRV may be used for the AMM system solely. Examples for protocols that may be used for NSRV are DNS, WINS and NETBIOS.

According to some embodiments, the AMM system's installation base may be varied, meaning that the system should be able to grow beyond its basic support level (i.e. adding more meters types), hence, configurability and easy maintenance of meters' protocol stacks is important.

According to some embodiments, as can be seen with reference to the operational flow chart illustrated in FIG. 1, AMM system 100 elements may cooperate to implement a Converter registration process, to automatically convert meter or client data for usage by a PLC system, prior to implementing AMR with a client. Accordingly, for example, a Converter 110 (e.g., an IP to Serial Converter), which may be coupled to a meter 115 or client, may convert data from meter 115 to an IP protocol. Meter 115 may have an interface that may transmit using serial, wireless (e.g. Zigbee, Bluetooth, WiFi etc.), RF, parallel, and any other suitable or available communication method. Converter 110 may get its Internet Protocol (IP) related configuration (e.g., IP address) and Name Server (NSRV) address via a Dynamic Host Configuration Protocol (DHCP) process. Converter 110 may obtain its IP and NSRV addresses manually using a predefined configuration. At stage 1, Converter 110 may send a name registration message to the NSRV 120 with a unique identifying Converter Name (CNAME). Name Server (NSRV) 120 may enable correlation of the CNAME and the Converter IP address. At stage 2, the NSRV may update PoCo 130, either by notifying it, or by the PoCo 130 initiating a continuous update check procedure. At stage 3, PoCo 130 may start a meter discovery process by accessing the Converter 110 (e.g., using IP via NAME access protocol). In stage 3, PoCo 130 may discover the Serial ID (SID) of the relevant AMR meter or client 115.

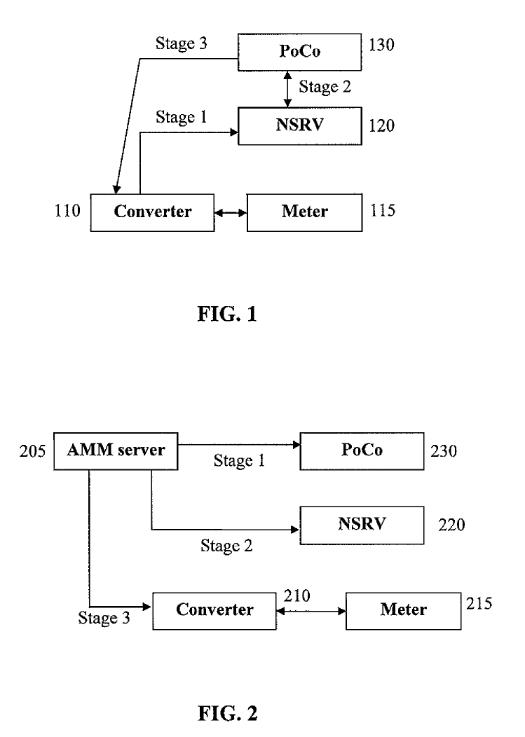

According to some embodiments, an AMM Server 205 may access the Converter in real time, as can be seen with reference to FIG. 2. At stage 1, the AMM Server 205, which may be an AMR management tool or system to enable management of multiple AMR units or clients in a PLC system, may send a query to the PoCo 230, asking for the CNAME correlated with the SID. AMM Server 205 may also request further information from PoCo 230, for example, meter type, protocol information etc. PoCo 230 may send meter connection information data, which may include, for example, CNAME, meter type, protocol information etc. to AMM Server 205. The AMM Server 205 may, at stage 3, access the Converter 210 using the NAME protocol, thereby accessing the relevant meter data. Converter 210 may be coupled to an AMR meter or client 215. Optionally, at stage 2, the Converter 210 may send a query to the NSRV, for example, if the PoCo did not provide the IP identification. The CNAME to IP process may connect between the AMM Server 205 and Converter 210. This process may be optimized using the AMM Server cache, however, each read action invoked by the AMM Server 205 should optionally have an authentication process before it (e.g., in order to assure that no meter had been replaced on the Converter level since the last update). By using CNAME instead of IP, the system does not need to keep an updated IP map for each device in the network; rather updates may be made using a standard protocol to a centralized Server.

According to some embodiments, in order to summarize different system elements knowledge range and relations between them, a relations tables may be maintained, for example, to include a general structure to store each network element's table structure (e.g., in terms of main fields). For example, where a unit with an internal Converter had been registered in the system, the unit's Ethernet MAC Address may be 00-03-6A-01-02-03, its IP address may be 192.168.10.1, and its derived name may be 101020302. A meter from type 02 may be connected to this unit, the meter's SID being 012345.

After the unit had registered itself to the NSRV, the NSRV may maintain the following SRV table:

| CNAME | IP address |
|---|---|
| I01020302 | 192.168.10.1 |

PoCo may either poll the NSRV for new entries or use signals to get updates from it. After detecting that a new CNAME exists, it may perform polling in order to detect whether there is a Meter connected to the new name, if so, what type of meter it is, and what its SID is. After the query has ended, the PoCo Table may include, for example:

| CNAME | SID | Type |
|---|---|---|
| I01020302 | 012345 | 02 |

When the AMM Server attempts to connect to Meter 012345, it may send a query to PoCo asking what the relevant CNAME is. PoCo may search for SID, and return (if found) the CNAME. From this point, the AMM Server may perform its query and IP connection directly to the meter itself (e.g., using CNAME query standard protocols).

Since PoCo is a service entity, it may provide several interfaces for notification and query, and it may also use external interfaces to perform updates and to notify other system elements about actions taken.

In one embodiment an AMM Server->PoCo Query interface may provide translations of SID to CNAME. The AMM Server may use this interface to make a query for a SID, in which case PoCo may return the relevant CNAME which will be used to access this SID.

In one embodiment a PoCo->AMM Server Notification interface may be provided. Whenever PoCo has detected a table inaccuracy (i.e. new/modified/deleted CNAME), it may notify the AMM Server of this new information.

In one embodiment a PoCo->NSRV Query interface may be provided, which may be able to read NSRV tables (e.g., including updated CNAME lists). In some embodiments the PoCo->NSRV Query interface may be used to enable a “pull mode” by which PoCo may pull or retrieve NSRV data from the NSRV.

In one embodiment a NSRV->PoCo Notification interface may be implemented. Whenever NSRV encounters a new CNAME or had aged out and deleted a CNAME from its list, it may notify PoCo regarding this update. In some embodiments the NSRV->PoCo Notification interface may be used to enable a “push mode” by which the NSRV may push or update the PoCo about changes to the NSRV data.

In one embodiment a PoCo->Meters Query interface may be provided. This interface may use a Meters stack (configurable and updatable), via IP protocol. PoCo may update its database information regarding SID to CNAME by querying new CNAMEs and verifying already added CNAMEs.

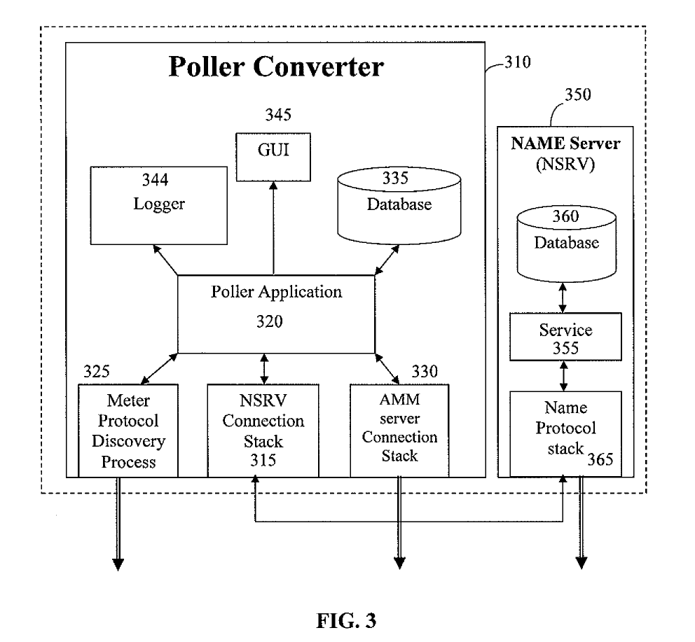

According to some embodiments, the PoCo System general architecture may include, for example, the components depicted in FIG. 3. As can be seen in FIG. 3, an implementation of an intelligent AMM system, sometimes referred to as “AmrPlus Poller system” built from two major components: Poller Converter (PoCo) 310 and NAME Server (NSRV) 350.

In this example, PoCo 310 and NSRV 350 are interconnected using PoCo's

NSRV Connection Stack 315. PoCo 310 may include one of more of the following sub-components: Poller Application 320, for initialization and run-time activity (i.e. validation of database entries); Meter Protocol Discovery Interface 325, for running the process to connect to Meters, wherein the interface “speaks” meter language (over IP protocol) and is used to connect to a Meter (using the IP Converter), and enable meter type detection, status and SID querying, etc.; NSRV Connection stack 315, to provide an interface on which PoCo 310 may get the list of registered names from NSRV 350, and use this list to invoke queries to detect new meters and update meters' status. In addition, this interface can be used for the NSRV 350 to proactively update the PoCo 310 about changes in its database; AMM Server Connection stack 330, which may be an interface between PoCo 310 and AMM Server, may be used by the AMM Server to invoke queries toward PoCo 310 (i.e. which NAME belongs to which SID) and to get a response. Additionally, this interface may be used in order to proactively update PoCo 310 in cases where meter information inaccuracy was detected; Database 335, which may contain the information of the meters, meter detection rules, etc.; Logger 340 , which may contain the activity which PoCo 310 handled (i.e. AMM Server queries, meters' status changes, user activity, etc.); and GUI 345, which is a user interface for manual update and information retrieval.

NSRV 350, according to some embodiments, may include one or more of the following sub-components: Service application 355, which may responsible to control the NSRV activities (i.e. registration, queries, delete of old entries); a Database 360, which may contain information about the NAMEs (i.e. IP address, registration time stamp), and optionally may contain additional data; and a Name Protocol Stack 365, which is an interface for interconnecting with IF devices for registration and queries using the NSRV defined protocol.

According to some embodiments, since the PLC system may not intrinsically “understand” the AMR serial world, the PLC system may act as a pipe connecting all the system elements together. In order for the PoCo to obtain the SID for each meter, it should have the capability to “speak” in the meter “language”. Since there may be several types of meters in the same system (which is the most common installation case), it should be able to discover the relevant meter languages. Further, since installation is scalable in its nature, an integrated configuration method may be supported. For example, a method may be provided to enable manual adding and configuration of a new protocol and/or type of meter, and/or by providing an option to configure and define sets of rules and actions to automatically detect the type of the meter(s) and the language it(they) speak(s).

There may be multiple methods to implement such processes. Using Manual Configuration (for example, with small scale installations), each CNAME entry (which may be known, since the modem or Converter connected to the meter can be registered during the installation process) on the PoCo database may contain a manual protocol ID with the relevant protocol (derived from the meter type). When the PoCo discovers such a unit to be connected, it may access the unit using the configured protocol only.

Using Automatic discovery, each new CNAME may invoke an automatic discovery process in order to detect which meter type is connected to it (and what its SID is). Rules may be defined on a rules manager module. Rules may use the CNAME structure in order to provide some clues about the meter type.

Other type of rules that may be applied may be proactive rules, for example, where the PoCo will try to send some meter commands to the Converter, and according to return replies (or no answer) it can detect the meter type. Rules may be fully configurable (e.g., with customer level tools) in order to support extension of the meter brands, types and languages in the field. During run-time, the auto discovery process may be invoked again, for example, in case a meter had stopped responding. For example, such a discovery process may be important in order to support cases where a meter had been replaced with a meter from another brand or type.

In another embodiment automatic discovery with manual override may be used, for example, to solve conflicts in special cases by optionally manually overriding both the meter language (protocol ID) or the SID connected to the Converter, when the automatic discovery is active and all other Converters should be supported.

According to some examples of this discovery mechanism, for example in a case where three types of Meters are installed in the system, a First Meter type may be deduced from the CNAME structure which the AMR modem or Converter creates. The other two types have the same CNAME structure; consider 3 CNAMEs for this example: X010101; I010102; I010103. Consider 3 possible languages which the PoCo supports: Language 1; Language 2; and Language 3. We know that all ‘X’ prefix CNAMEs use Language 1, so the automatic procedure should search for “X” as a prefix, and allocate the type—Language 1, to it.

The two other types may be detected using a proactive test—we may send a command which only Language 2 answers to it, if the CNAME will answer with a legal reply (that fits language 2 rules)—it may be tagged as a Language 2 type. There may be two different languages that use the same command but use the reply structure to differentiate between them. If there is no answer, it doesn't necessarily show that the CNAME is Language 3 type—it may be a disconnected Meter, so verification rules to Language 3 type should be defined as well. In this example, there may be two constant “types” for the cases of DISCONNECTION and UNKNOWNTYPE (where a reply was received, however it doesn't match any of the defined rules). Proactive messages may be different from each other not only by their payload structure, but also in their infrastructure (i.e. UDP/TCP, ports numbers etc.).

According to one example, in order to simulate a Meter language, the Meter may have two ways of installation, for example, using external Converters (e.g., which may use UDP with port 1000 to access), and using internal Converters (e.g., which may use UDP with port 2000).

From the reply message in can be deduced which type of Meter answered the request. In addition, the PoCo may obtain its SID using the Customer Number field. In order to access a Meter in this scheme (e.g., only a single Meter type, but have different UDP port to access), a trial-and-error method may be used, or the CNAME structure may be used, which may be different (for instance, External Converters names will begin with ‘X’ while internal Converters will begin with T). In some embodiments the rules structure should support (in general) the Trial-and-Error detection rules and CNAME parsing rules.

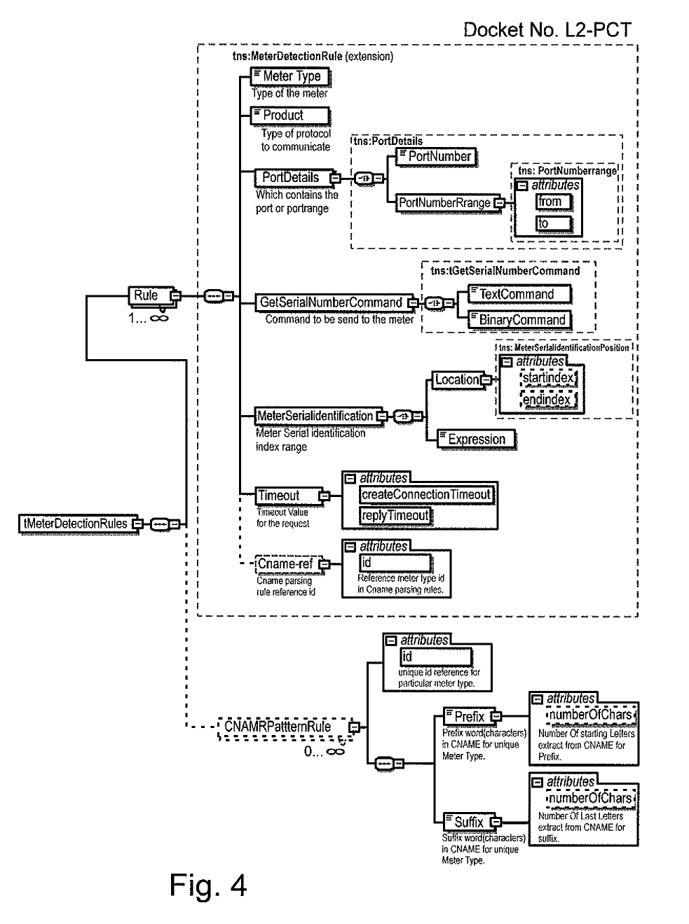

An example for Automatic Meter Rules Implementation is described in FIG. 4. In this example an Automatic Meter Rules implementation or Automatic Discovery, may be operated for each new CNAME (Converter Name) detected on the NSRV database. Each query stage/property is represented by a separate box. In the example illustrated, CNAMEPatternRule is a set of inner rules which use the CNAME structure in order to define a smaller list of rules, i.e. different prefix character may imply that the Converter serves a specific meter type, hence, simplify the process for detecting a meter type. Inside this Rule, the following rules exist: Id—specific rules to an ID (i.e. manual configuration for a CNAME); Prefix—analyze the beginning of the CNAME string and define the relevant set of rules that match it; Postfix—analyze the end of the CNAME string and define the relevant set of rules that match it; Rule—based on CNAMEPatternRule, the sets of rules which are being implemented on a CNAME.

Each Rule may be built from the following definitions: MeterType—unique ID for a Meter type language; Protocol—transport protocol over IP (i.e. UDP, TCP); PortDetails—either defined PortNumber, or a range of port numbers—PortNumberRange—limited by “From” and “To”; GetSerialNumberCommand—define the command which will be sent using the IP transport protocol, this command can be text based (using TextCommand) or binary (using BinaryCommand). This command will be sent toward the meter, and if reply that matches the protocol will receive—the meter type is detected; MeterSerialIdentification—analyze the reply message (if received) and get the Meter SID from it using either Location (on textual based reply between “startIndex” and “endIndex”) or by using Expression that may translate binary response to a SID value; TimeOut—definition for time to wait between sending the SerialNumberCommand until MeterSerialIdentification reply is being received. This setting is useful for the trial-and-error process wait time. Inner parameters define times to open connection (createConnectionTimeout—relevant for connection oriented protocols i.e. TCP) and time to wait for a response (replyTimeout); and Cname-ref—defines manual override rules.

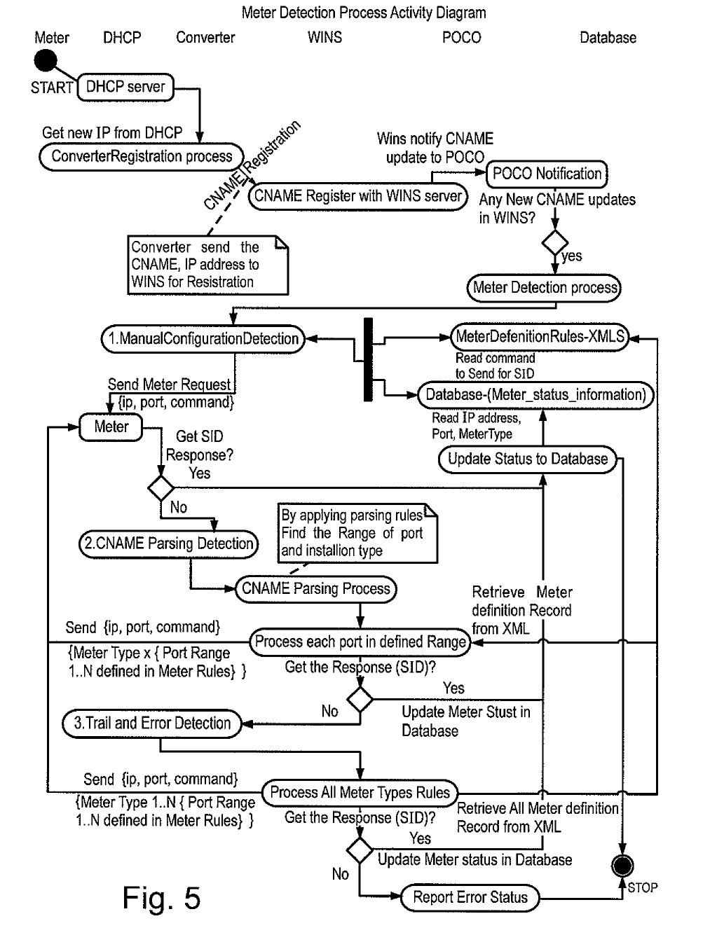

An implementation example which uses Windows Internet Naming Service (WINS) as its NSRV protocol, and covers substantially the full process of meter auto detection, meter query and the database relationship, can be seen with reference to FIG. 5.

A CNAME Table may be provided to hold the updated CNAME and the most recent information. Past information may be deleted (since the logger module should hold it), for example:

| Field name | Field type | Notes |
|---|---|---|
| CNAME | STRING | Used to keep the CNAME value of the |
| | | meter, which is its IP connectivity address. |
| TYPE_INT | INTEGER | Type of Meter which will be define |
| | | (according to field requirement and its |
| | | installation base) the meter protocol which |
| | | should be used to communicate with the |
| | | Meter. |
| SID | STRING | Serial ID of the meter. May contain letters |
| | | and digits. |
| CONNECTION_DATE | DATE_TIME | Initial type on which the CNAME had been |
| | | added to the table. Kept for fast tracking. |
| CONNECTION_IP_LAST | DATE_TIME | Last type of meter to which the CNAME |
| | | had responded using an IP based |
| | | transmission (i.e. PING). |
| CONNECTION_SR_LAST | DATE_TIME | Last type of meter which the CNAME had |
| | | responded to using a Serial based |
| | | transmission - which shows that the meter |
| | | was connected at this time. |

TYPE_INT value may correspond with the Meter Types Table which may correlate between INT value and STRING, which may hold a textual reference to the Meter type. Its value may be set by the application either by the automatic detection mechanism, or using the manual configuration table.

A Meter Types Table may be used to store the correlation between TYPE Integer value and the textual reference describing it.

| Field name | Field type | Notes |
|---|---|---|
| TYPE_INT | INTEGER | Type of Meter which will define (according |
| | | to field requirement and its installation |
| | | base) the meter protocol which should be |
| | | used to communicate with the Meter. |
| TYPE_TEXT | STRING | Textual reference of the Meter TYPE. |

This table may be set by the user while defining the required meter types that the PoCo should support. It may have a close relationship with the Automatic Detection mechanism, which may return the TYPE_INT value when the Meter type has been detected.

A Manual Configuration Table may be provided, which may hold manual configuration data (and which may override options in case the user wants to manually configure a special Meter with a different value). This may be set by the user. Every new CNAME may try to first search on the Manual configuration table for matching entries that specify the meter Type and SID, and only if this is not found—it will start the Automatic Detection mechanism.

The table may hold the following fields:

| Field name | Field type | Notes |
|---|---|---|
| CNAME | STRING | Use to keep the CNAME value of the meter, |
| | | which is its IP connectivity address. |
| TYPE_INT | INTEGER | Type of Meter which will define (according |
| | | to field requirement and its installation |
| | | base) the meter protocol which should be |
| | | used to communicate with the Meter. |
| SID | STRING | Serial ID of the meter. May contain letters |
| | | and digits. |

The NSRV Connection stack, including the NSRV (Name Server) may be implemented as a service within the PoCo application. However, due to the fact that it may optionally be separated to a different machine, a standard interface may be used in order to interconnect between the PoCo entity and the NSRV entity.

The AMM Server may use the PoCo as a knowledgebase entity for accessing SIDs over IP. It may use queries in order to get the CNAME of each requested SID. After receiving a successful response with the corresponding CNAME to the requested SID, the AMM Server may perform its actual data connection mechanism—for example, after performing its verification procedure in order to ensure that the information it received from the PoCo is up to date (for instance, there might be several cases in which a meter had been replaced or switched between Converters and PoCo did not made an update round yet on the relevant CNAMEs). In addition, the PoCo may return other answers in the case where the SID was not found, or when SID existed in the database, yet when the CNAME is marked as disconnected.

When the AMM Server detects an inaccuracy in the information it received from the PoCo it may be able to notify and alert the PoCo in order that the PoCo will be able to update its tables. The PoCo may also use this notification to accelerate the relevant CNAME's to make updates (i.e. if a SID that was found by the AMM Server is registered on the PoCo tables under another CNAME, it may verify or modify this CNAME too).

To summarize, a PoCo query protocol may be provided, which may be used by the AMM Server in order to obtain requested CNAME's to given SID. Answers may include one or more of: CNAME String; Not found answer; Disconnected answer; and PoCo notification protocol—the protocol which AMM Server uses in order to warn the PoCo about inconsistency it found in its tables.

Other possible interfaces that may be defined (if needed) are: AMM Server notification protocol—in case the PoCo will work on push mode and will notify the AMM Server about new CNAMEs and SIDs and about changes in its tables); PoCo authentication protocol—in case the system will define that every change that PoCo had found needs to be authorized first by the AMM Server before making it active (e.g., in order to “catch” intrusions, unauthorized installation modifications and breaks into the system); and a Poller Application, to maintain SID to CNAME Accuracy.

Due to the fact that PoCo should give accurate information regarding the relevant Meter SID corresponding CNAME string, it may maintain, beside the new unit handling procedure (which was described in the previous chapter) a run-time mechanism which may perform accuracy constant checks to find, for example, disconnections of Meters, Meter replacements and Meter reinstallations etc.

In summary, the New name tracking and detection mechanism may be implemented to constantly check for changes (e.g., running on every known CNAME and performing validation to see if the meter is connected and that the meter data as maintained by the PoCo is accurate and/or updated), to track deleted names (e.g., in case a CNAME was aged out), and track name changes (e.g., since a customer may cause a change in internal configuration which might affect the CNAME sting). In cases of CNAME string changes, such changes may be supported (e.g., extension for CNAME deleted and CNAME added cases).

The PoCo application may therefore be able to implement NSRV Database polling and PoCo Database polling. The NSRV Database polling task may include polling the NSRV Database in order to locate changes on the Name Server side which have effect on the PoCo information. Changes like IP address replacement may not interest the PoCo since it may work on the NAME access layer. However, new CNAMEs added to the NSRV database, deleted CNAMEs, and possibly CNAME structures that had been changed (TBD) may cause the PoCo to start polling to the new/altered CNAME and to change states to a deleted CNAME.

The PoCo Database polling task may pass over all CNAMEs in the database, so that each CNAME may be checked at every CHECK_INTERVAL (a parameter that needs to be set). Since every CNAME check may require a time interval to be completed, in accordance with the meter type, for example, a CNAME check may require up to 30 seconds each, or any other suitable time interval (e.g., due to the fact that meters may use serial interfaces with relatively slow transmission rates), this mechanism may work with multiple threads in order to complete a plurality of tests in parallel.

The polling task's goal may include tracking databases changes, CNAMEs which have been disconnected, switches between Meters, replaced Meters, disconnected Meters, etc. In order to check that a Converter is connected to the IP backbone (whether no Meter may be connected to it, or is connected, but is not working etc.), the Application may use, for example, ICMP protocol. When a Meter (SID) does not respond, the PoCo may try to PING it. If the Meter did not respond, but the CNAME had PING responses, it may mean that, for example, the Converter is connected, but the Meter is either disconnected or malfunctioning.

Glossary

| | |
|---|---|
| PoCo | Poller-Converter, AMM system element, correlating between SID and |
| | Converter NAME. |
| NSRV | Name Server, correlating between NAME of device to its IP address. |
| | May use WINS, SAMBA, or other standard naming protocol. |
| SID | Serial ID - identifier of a meter. Correlates between customer and a |
| | meter. |
| CNAME | Converter Name - a name created by the AmrPLUS units, in order to |
| | notify the NSRV about an internal or external Converter connected to |
| | them. |
| PLC | Power Line Communication |
| AmrPLUS | Automatic Meter Reading capable PLC units |
| WINS | (Windows Internet Naming Service) Name resolution software from |
| | Microsoft that runs in Windows NT and 2000 servers. It converts |
| | NetBIOS names to IP addresses. |
| DNS | (Domain Name System) A system for converting host names and |
| | domain names into IP addresses on the Internet or on local networks |
| | that use the TCP/IP protocol. |
| NETBIOS | The original networking protocol for DOS and Windows PCs. Today, |
| | NetBIOS is used to support legacy NetBIOS applications but is also |
| | widely used for NetBIOS name resolution. |
| GUI | Graphic User Interface |
| ICMP | RFC 792, Internet Control Message Protocol |
| SAMBA | Samba is a free software implementation of Microsoft's networking |
| | system released under the GNU General Public License |

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A system for enabling automated correlating of AMR data in a broadband PLC system, comprising:
an Automated Meter Management (AMM) Server to serve Automated Meter Reading (AMR) data to the PLC system;
a Converter, to convert data from a Meter to an IP protocol;
a Name Server (NSRV), to correlate a Converter Name (CNAME) and Converter IP address; and
a Poller Converter, to provide said CNAME and Meter information data to said AMM Server.

2. The system of claim 1, wherein said name Server includes a service application and a Name Protocol Stack.

3. The system of claim 1, wherein said Poller Converter includes a Poller application associated with a NSRV Connection Stack and an AMR Connection Stack.

4. The system of claim 1, wherein said Poller Converter includes a Poller application associated with a logger unit and a Name database.

5. The system of claim 1, wherein said automated correlation occurs substantially in real time.

6. The system of claim 1, wherein said automated correlation is executed substantially simultaneously for multiple AMR clients.

7. A method for enabling automated correlation of AMR data in a broadband PLC system, comprising:
implementing an automated registration process to associate a Converter with an AMR client;
using a Name Server (NSRV) to keep an updated list of Converter Name-to-IP data;
correlating a Converter Name and Serial ID (SID) for each client; and
obtaining client AMR data to be provided to the PLC system.

8. The method of claim 7, comprising authenticating a meter state before obtaining client AMR data.

9. The method of claim 7, wherein said registration process comprises:
receiving IP Configuration data from a DHCP process, by a Converter;
using a Name Server (NSRV) to get an NSRV address for an AMR client, by said Converter;
sending a name registration message to said NSRV, with a unique identifying Converter Name (CNAME);
updating a Poller Converter (PoCo) with said CNAME for each client; and
starting a meter discovery process, by said PoCo, by accessing said Converter.

10. The method of claim 7, wherein said obtaining client AMR data comprises:
sending a query to a PoCo asking for the CNAME correlated with said SID;
using said CNAME, by said AMM Server, to access said Converter; and
using said CNAME to IP process to connect between said AMM Server and said Converter.

11. The method of claim 8, wherein an authentication process precedes said read action invoked by said AMM Server.

12. A process to enable automated AMR management in a broadband PLC system, comprising:
automatically registering an AMR client on the PLC system; said registering being handled by a Poller Converter (PoCo) unit coupled to a Name Server; and
accessing said AMR client in real time, by an AMM Server, to provide broadband AMR management.
